(19) United States
(12) Patent Application Publication
(10) Pub. No.: US 2006/0215895 A1
(43) Pub. Date: Sep. 28, 2006

(54) Medical image displaying apparatus

(75) Inventor: Takanori Ando, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/386,286

(22) Filed: Mar. 21, 2006

(30) Foreign Application Priority Data
Mar. 22, 2005 (JP) 2005-081725

(51) Int. Cl. G06K 9/00

(52) U.S. Cl. 382/128

(57) ABSTRACT

A medical image displaying apparatus includes a display unit to display a medical image in a display frame, an operation unit to instruct movement operation to move the medical image displayed in the display frame into another display frame, and a display control unit to move the medical image displayed in the display frame into the another display frame and to display according to the movement operation instructed by the operation unit.

### BACKGROUND OF THE INVENTION

1. Field of the Invention

The present invention relates to a medical image displaying apparatus for displaying medical images.

2. Description of the Related Art

In the field of medical care, digitization of medical images obtained from examination imaging has been realized, and diagnosis using monitors has been carried out instead of diagnosis using conventional films. In the diagnosis using monitors, a medical image subject to interpretation and medical images subject to comparison are displayed on a plurality of monitors as shown in FIG. 10A, or a plurality of images are displayed on a plurality of divided display areas on one monitor as shown in FIG. 10B (see, for example, JP 2000-166878 A).

When diagnosis has been performed using films, various kinds of methods for interpreting images have been adopted, such as superposing films on each other, changing observation directions by rotation of a film, and the like. Similarly, a technique capable of displaying a medical image with rotation on a monitor has been developed (see, for example, JP 2001-223886 A).

However, when the plurality of monitors are used, amount of movement of a doctor's view-direction becomes large; which makes the doctor exhausted. In the case where the plurality of images are arranged and displayed on one monitor, doctor's view-direction movement between display frames is also inevitable, which causes severe exhaustion to the doctor. Particularly, in case of CT (Computed Tomography), MRI (Magnetic Resonance Imaging), or the like, very large number of images, a unit of about 100 images per one examination, is produced. It is therefore preferable that view-direction movement is as small as possible when interpreting such medical images.

### SUMMARY OF THE INVENTION

An object of the invention is to provide a medical image displaying apparatus capable of reducing view-direction movement in case of image interpretation.

In order to achieve the above object, a medical image displaying apparatus according to an embodiment reflecting one aspect of the present invention comprises:

a display unit to display a medical image in a display frame;

an operation unit to instruct movement operation to move the medical image displayed in the display frame into another display frame; and

a display control unit to move the medical image displayed in the display frame into the another display frame and to display according to the movement operation instructed by the operation unit.

According to the medical image displaying apparatus of the present invention, medical images displayed in different display frames can be moved to one identical display frame and displayed. Therefore, a plurality of medical images subject to interpretation for comparison can be disposed together within one display frame, which minimizes view-direction movement of the doctor when interpreting images.

Preferably, the display control unit displays the medical image and the another medical image in a state of being superposed on each other, in case the medical image is moved to a position where the medical image is superposed on the another medical image by the movement operation.

According to this invention, since each medical image can be displayed in a superposed state, the amount of view-direction movement of the doctor can be reduced.

Preferably, the display control unit switches display order for each of the medical image and the another medical image that are displayed in a state of superposition.

According to this invention, arrangement order of the superposed medical images can be switched, and therefore the display can be switched to a state with easier interpretation as desired, such as disposing a desired image in front.

Preferably, the display control unit displays the medical image and the another medical image, at an overlapped portion, so that a medical image disposed in behind can be observed through a transparent medical image disposed in front.

According to this invention, the overlapped portion is displayed in such a state that the image in front is transmitted through, which allows observation of images in a similar way as in the image interpretation with films superposed.

Preferably, the display control unit applies display control to a plurality of medical images displayed in identical display frame.

According to this invention, the control unit applies the display control, such as positional movement, switching of display with a series of images, to the plurality of medical images within one display frame. Therefore, the doctor can perform display operation collectively with one operation, thereby improving working efficiency when interpreting images.

Preferably, the medical image displaying apparatus further comprises:

an image processing unit to perform image processing to the medical image; and

a processing control unit to apply the image processing to a plurality of medical images displayed in identical display frame.

According to this invention, the control unit applies image processing to the plurality of medical images within one display frame. Therefore, the doctor can perform image-processing operation collectively with one operation, thereby efficiency of work can be improved.

### BRIEF DESCRIPTION OF THE DRAWINGS

The present invention will become more fully understood from the detailed description given below and the accompanying drawings, which are not intended to limit the present invention, and wherein:

FIG. 1 is a diagram showing an internal structure of a medical image displaying apparatus according to the present embodiment;

FIG. 2 is a diagram showing an example of data structure of a display frame management table;

FIGS. 3A to 3E are a diagrams showing an example of patient information, examination information, series information, and detailed image information, with their relation;

FIG. 4 is a flowchart that explains an image displaying processing executed by the medical image displaying apparatus;

FIGS. 5A to 5C show examples in which a plurality of medical images are moved to one display frame;

FIGS. 6A to 6C show examples of display control for medical images superposed on each other within one display frame;

FIG. 7 is a flowchart that explains an image editing processing executed by the medical image displaying apparatus;

FIG. 8A shows a selected state in case that all medical images are selected;

FIG. 8B shows a selected state in case that a medical image within one display frame is selected individually;

FIG. 9A shows a display example in case that a plurality of medical images within one display frame are moved in synchronism with each other;

FIG. 9B shows a display example in case that display of medical images is switched in synchronism with each other;

FIG. 9C shows a display example in case that image processing for each medical image is synchronized with each other;

FIG. 10A shows a conventional display example of medical images in case of using a plurality of monitors; and

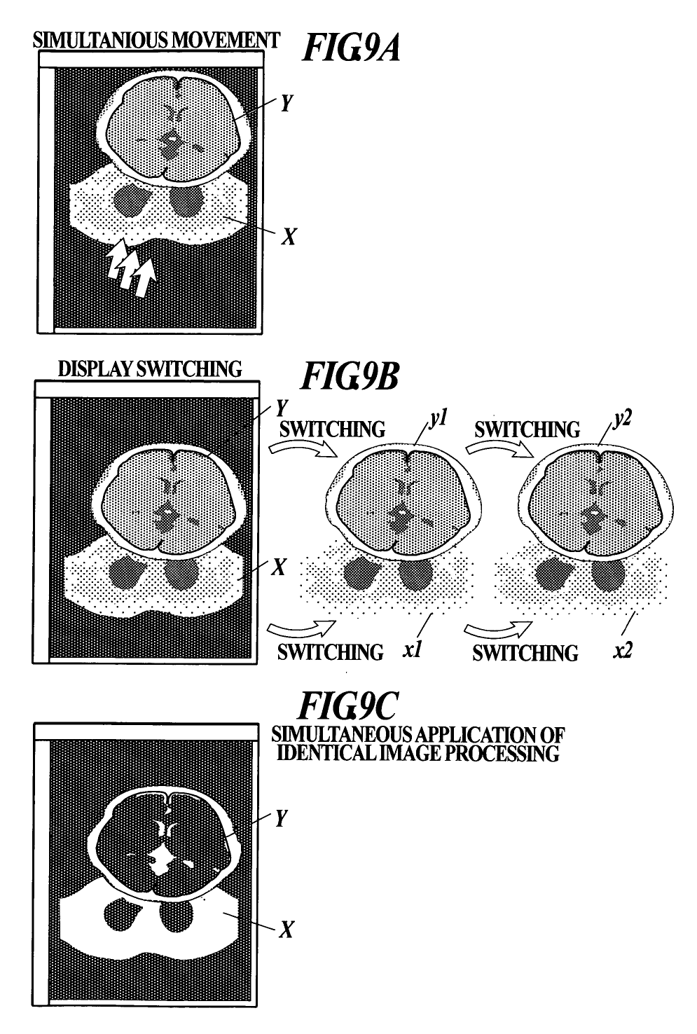

FIG. 10B shows a conventional display example of medical images in case of displaying the medical images in one screen.

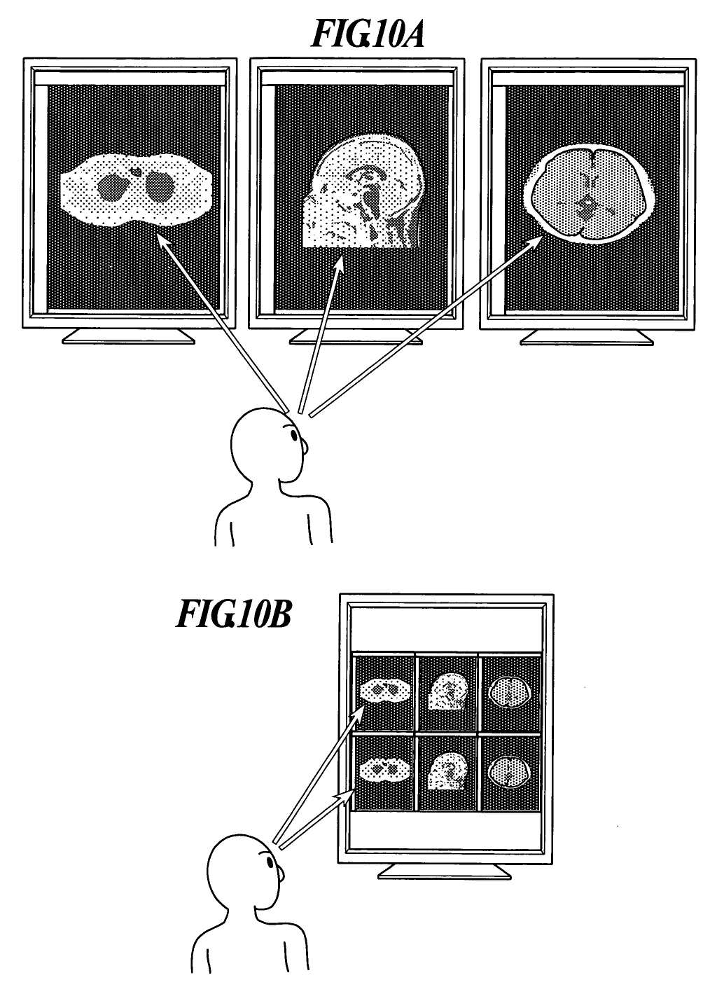

### PREFERRED EMBODIMENT OF THE INVENTION

Hereinafter, the preferred embodiment of a medical image displaying apparatus according to the invention will be described with reference to the accompanying drawings.

First, the structure of the apparatus will be described.

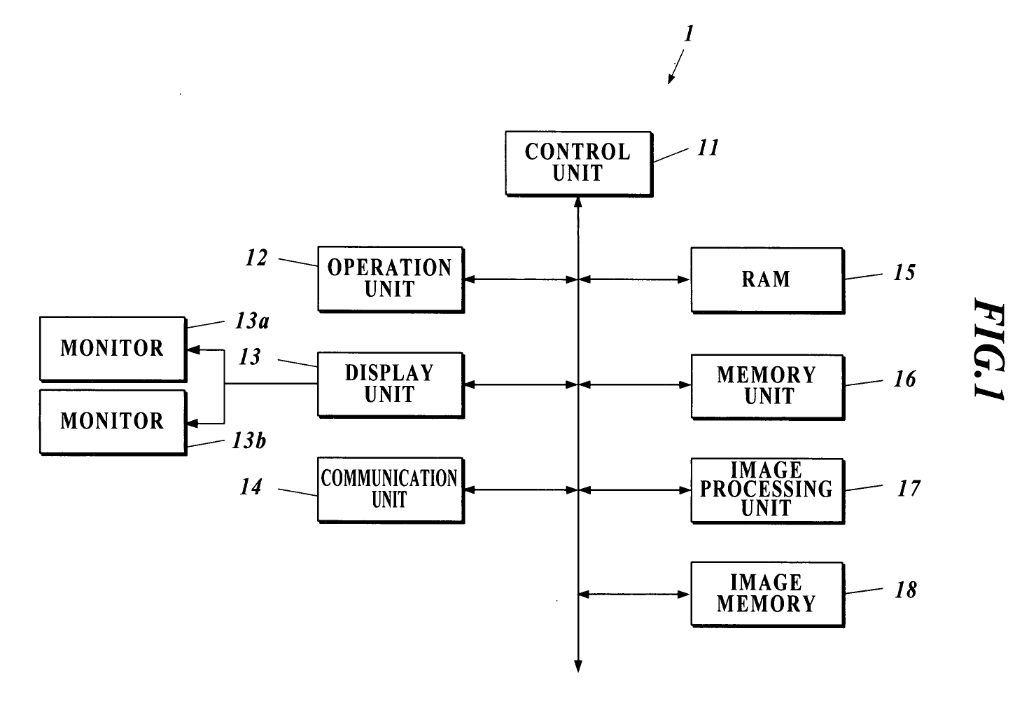

FIG. 1 shows an internal structure of the medical image displaying apparatus 1 according to the embodiment.

As shown in FIG. 1, the medical image displaying apparatus 1 comprises control unit 11, operation unit 12, display unit 13 provided with monitor 13a and monitor 13b, communication unit 14, RAM (random access memory) 15, memory unit 16, image processing unit 17, and image memory 18.

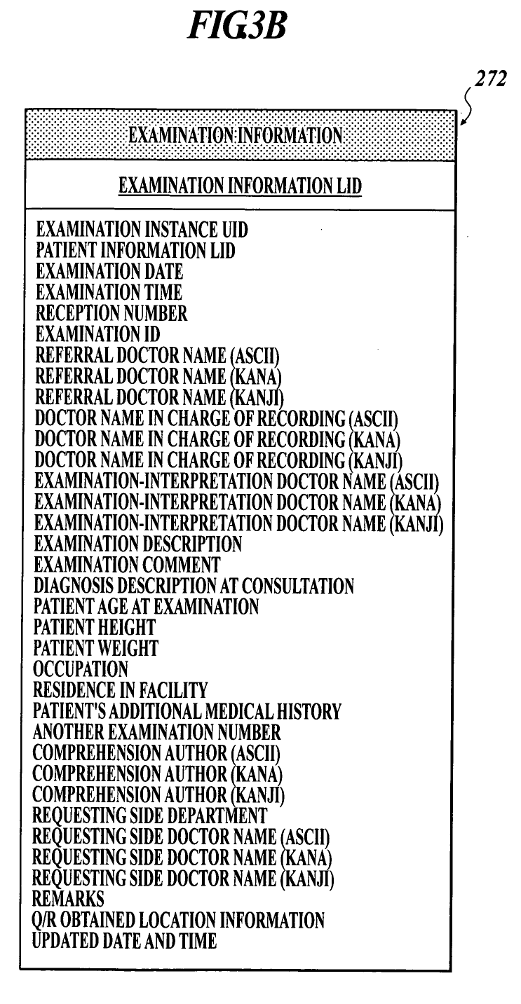

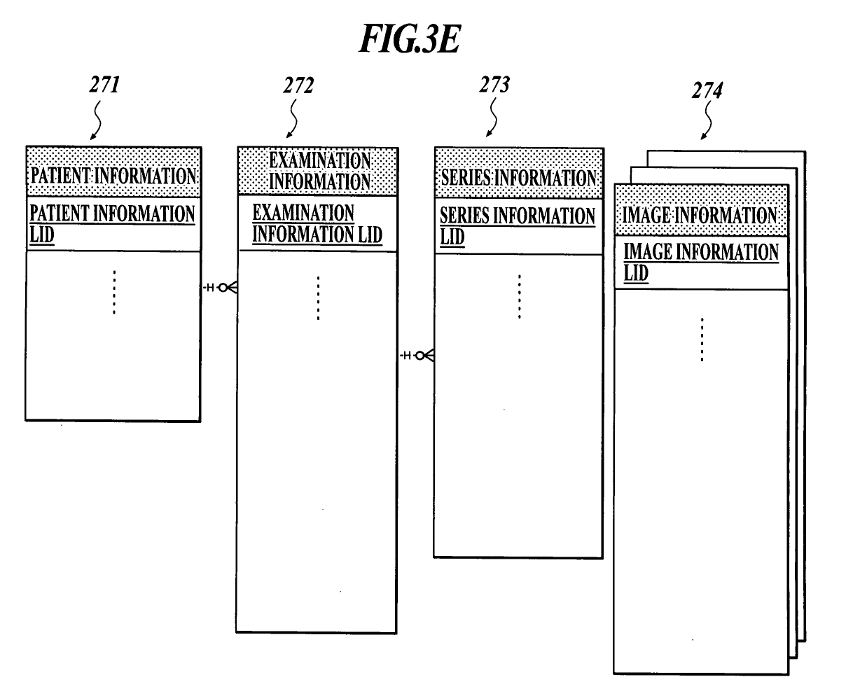

The control unit 11 comprises a CPU (Central Processing Unit), and the like. The control unit 11 reads out from the memory unit 16 various kinds of control programs, such as image display processing program (see FIG. 4), an image edit processing program (see FIG. 7), and the like, according to the present invention, and performs various arithmetic operations as well as controls the overall execution of processing (detail of which described later) according to the programs.

The operation unit 12 comprises a keyboard, a mouse, and the like, and generates an operation signal in association with the operation of the keyboard and the mouse, and outputs the signal to the control unit 11.

The display unit 13 comprises monitors 13a and 13b, each composed of an LCD (Liquid Crystal Display) or the like, and displays various kinds of display screens, such as an operation screen, medical images, and the like on the monitors 13a and 13b according to commands from the control unit 11.

The communication unit 14 is provided with a communication interface such as a router, a modem, and the like, and sends/receives various kinds of data within external devices connected through a communication network according to commands from the control unit 11. For example, the communication unit 14 receives medical images subject to display from a modality, and sends processed images that have been applied with image processing, to external devices such as a management server, a film output device, and the like.

The RAM 15 is a work memory to store data temporarily, and stores data, processing results, and the like of programs expanded by the control unit 11.

The RAM 15 also stores a display frame management table 15a. The display frame means a certain display area used for displaying medical images. As for an initial display, one medical image is displayed within one display frame. Subsequently, another medical image can be transferred from another display frame into the one display frame to display a plurality of medical images within the identical one display frame. Therefore it is necessary to manage medical images displayed in each display frame. The display frame management table 15a is table information to manage medical images displayed within a display frame for every display frame.

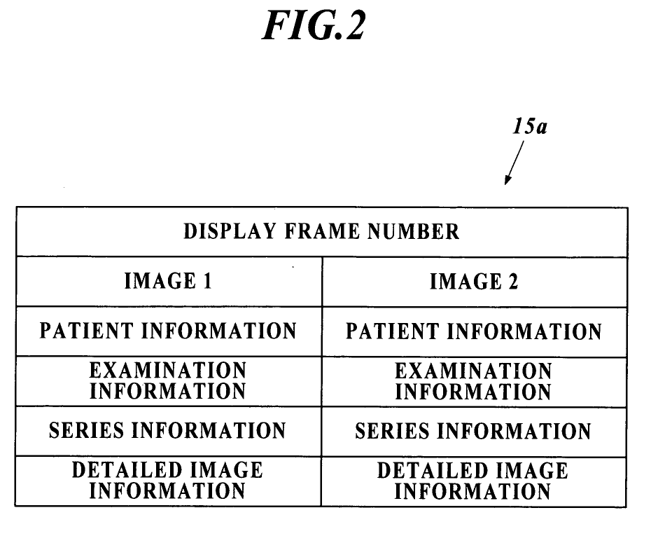

As shown in FIG. 2, the display frame management table 15a stores a display frame number (The display frame number is given in the order of preparation of a display frame.) to identify each display frame, and an image number (The image number is given in the order of display of an medical image. In FIG. 2, two images are displayed, and image numbers of 1 and 2 are given to each.) to identify each medical image displayed within the display frame. In association with each image number, the table 15a stores patient information, examination information, series information and detailed image information as the information relating to the medical image (contents of the information will be explained later).

The memory unit 16 stores above-described various kinds of control programs, various kinds of parameters necessary for executing the programs, processing results, and the like.

The image processing unit 17 performs necessary image processing to the medical image. The image processing includes, for example, reduction/expansion processing, tone-change processing, sharpness adjustment processing, dynamic range compression processing, and the like.

The image memory 18 is a memory to store medical images subject to display. When a medical image is generated, various kinds of information concerning the medical image is accompanied to the medical image, and the image memory 18 manages each image based on the accompanying information.

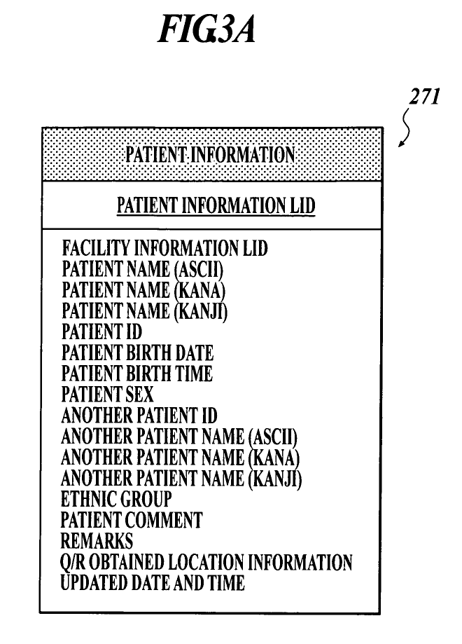

FIG. 3A through FIG. 3E show an example of the accompanying information.

As shown in FIG. 3A through FIG. 3E, the accompanying information includes patient information Z1, examination information Z2, series information Z3 and detailed image information Z4, and the information Z1-Z4 is in association with each other.

The patient information Z1 includes various kinds of information, relating to a patient of whom the medical image is photographed, such as a patient name, patient ID, patient sex, and the like, and are associated with patient information LID (ID given to identify the patient information individually).

The examination information Z2 includes various kinds of information relating to the examination, such as examination date, examination ID, doctor name in charge, and the like, and are associated with examination information LID (ID given to identify the examination information individually). The examination information Z2 is associated with the patient information Z1 by the patient information LID.

The series information Z3 is information relating to a series of imaging in a case that different kinds of imaging, such as CT and MRI, have been carried out in one examination. The series information Z3 includes the information relating to the series of imaging in one examination, such as name of a modality used in the imaging, series number, examination region, and the like, and are associated with series information LID (ID given to identify the series information individually). The series information Z3 is associated with the examination information Z2 by the examination information LID.

The detailed image information Z4 includes detailed information relating to the medical image, such as image number, imaging date the image production, imaging time, reading conditions (allocated bit, storing bit, and the like) when producing the image, and are associated with detailed information LID (ID given to identify the detailed image information individually). The detailed image information Z4 is associated with each of the examination information Z1-Z3 by the patient information LID, the examination information LID, and the series information LID.

Next, the operation of the medical image displaying apparatus 1 will be described.

FIG. 4 is a flowchart that explains an image displaying processing executed by the medical image displaying apparatus 1 when interpreting images.

As an assumption concerning the following description, a patient and an examination subject to interpretation is selected in advance by a doctor, and a selection screen to select medical images corresponding to the patient and the examination is displayed on the monitors 13a and 13b.

In the image displaying processing shown in FIG. 4, a medical image selected by the doctor through the operation unit 12 is read out from the image memory 18 by the control unit 11, disposed in one display frame, and displayed on the monitor 13a (step S1). This display frame for the first display is referred to as a display frame A. In addition, the display frame management table 15a in association with the display frame A is generated by the control unit 11 in the RAM 15. Subsequently, the patient information Z1, the examination information Z2, the series information Z3, and the detailed image information Z4, which relate to the medical image displayed in the display frame A, are stored in a memory area corresponding to the display frame A, and are managed. (step S2).

Next, based on the patient information, the examination information, or the series information, which are stored in the display frame management table 15a, it is determined whether a medical image associated with the relating examination exists (step S3). The relating examination means an examination relating to the examination performed this time, including, for example, an examination performed in the past for the identical region of the identical patient. The medical image associated with the relating examination is searched with reference to the accompanying information of each medical image stored in the image memory 18. For example, when there is an accompanying information that has patient name, patient ID, and examination region identical to those of the current one and a past examination date, a medical image of the accompanying information is determined to be a medical image for the relating examination.

In case no medical image for the relating examination is found (“N” at step S3), the processing ends.

Meanwhile, in case a medical image for the relating examination is found (“Y” at step S3), the found medical image is read out from the image memory 18 by the control unit 11, disposed within another display frame (referred to as a display frame B) different from the display frame A, and displayed on the monitor 13b (step S4).

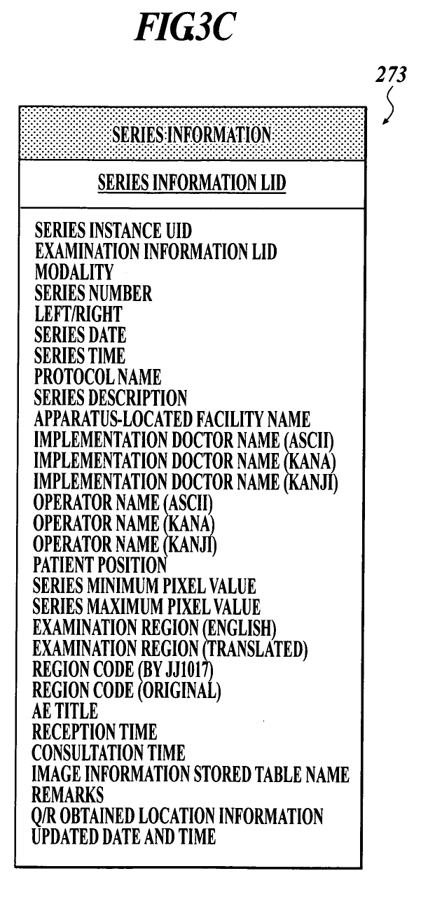

FIG. 5A shows an example of medical images displayed in the display frames A and B.

The display frame A is displayed on the monitor 13a, having a medical image X imaged by CT displayed therein. Similarly, the display frame B is displayed on the monitor 13b, having a medical image Y imaged by CT displayed therein.

Moving operation can be applied to each of the medical images X and Y displayed in the respective display frames A and B. The moving operation may be performed by drag-and-drop operation with a mouse, cut-and-paste operation, commanding operation of the moving direction by a cursor key or the like after the medical images X or Y subject to moving operation is selected, and the like.

In the medical image displaying apparatus 1, the control unit 11 determines whether the moving operation has been applied to the medical images X or Y through the operation unit 12 (step S5). In case the moving operation is not applied (step S5; N), the processing moves on to step S4 and continues to display the medical images X and Y. In case the moving operation is applied (step S5; Y), the control unit 11 which received an operation signal from the operation unit 12 calculates a coordinate position after movement according to the amount of operation (step S6).

Subsequently, it is determined from the calculated coordinate position whether the displayed images X or Y has been moved over from the frames A or B in which the images are currently disposed, to the other display frames B or A (step S7). For example, in case that the moving operation has been applied to move the displayed image Y into the display frame A as shown in FIG. 5B, the coordinate position after movement moves over the display B and is within the coordinate position in the display frame A. Therefore, it is determined that the image Y has been moved into the other display frame A.

In case the coordinate position after movement is within the identical display frames A or B as that before movement (step S7; N), the displayed images X or Y is moved to the calculated coordinate position after movement within the identical frame and displayed (step S8).

On the other hand, in case the image disposed in the display frames A or B before movement has been moved to the different display frames B or A (step S7; Y), the displayed images X or Y is moved to the calculated coordinate position within the display frames B or A after the movement and displayed (step S9). For example, when the moving operation has been applied to move the displayed image Y to the display frame A as shown in FIG. 5C, the displayed image Y is deleted from the monitor 13b and displayed in the display frame A on the monitor 13a after the movement.

When display after movement is displayed, patient information Z1, examination information Z2, series information Z3, and detailed image information Z4 relating to the displayed image X or Y after movement are overwritten from the display frame management table 15a corresponding to the display frame A or B before movement to the display frame management table 15a corresponding to the display frame A or B after movement, and are managed (step S10). In the example shown in FIG. 5C, each of the information Z1-Z4 of the displayed image Y is written in the display frame management table 15a of the display frame A, and each of the information Z1-Z4 of the displayed image Y is deleted from the display frame management table 15a of the display frame B.

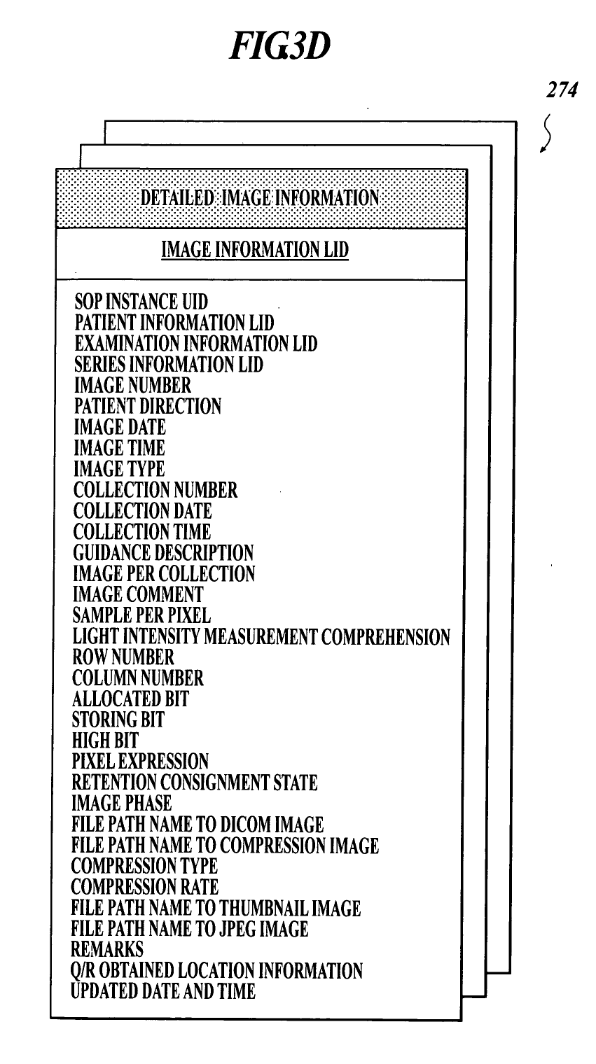

Here, as shown in FIG. 6A, in case that a plurality of images are disposed in one identical display frame after movement so as to be overlapped partly with each other, it is selectable whether which of the images is disposed in front of or in behind of another image. For example, when the displayed image Y is selected to be disposed in front, the displayed image Y is displayed in front with priority at the overlapping portion of the displayed images X and Y as shown in FIG. 6A. To the contrary, when the displayed image Y is selected to be disposed in behind, the displayed image X is displayed in front with priority at the overlapping portion of the displayed images X and Y, and the image Y is in behind, as shown in FIG. 6B.

It is also possible to display the overlapping portion in a transparent state as shown in FIG. 6C. When the doctor operates through the operation unit 12 to instruct a transmitted display, the image processing unit 17 performs image processing so that the image X or Y disposed in front is transmitted though at the overlapping portion of the images X and Y and the image Y or X disposed in behind can be observed, and then displays the image. The image processing for the transparent state includes, for example, obtaining difference between pixel values of the displayed images X and Y, multiplying the difference with a predetermined coefficient, and displaying the image with the multiplied pixel value.

Next, a description will be given for an image editing processing, executed in case the plurality of medical images moved and disposed in one display frame as mentioned above, are further subject to movement of display position, execution of image processing, switching of display, and the like.

FIG. 7 is a flowchart explaining a flow of the image editing processing.

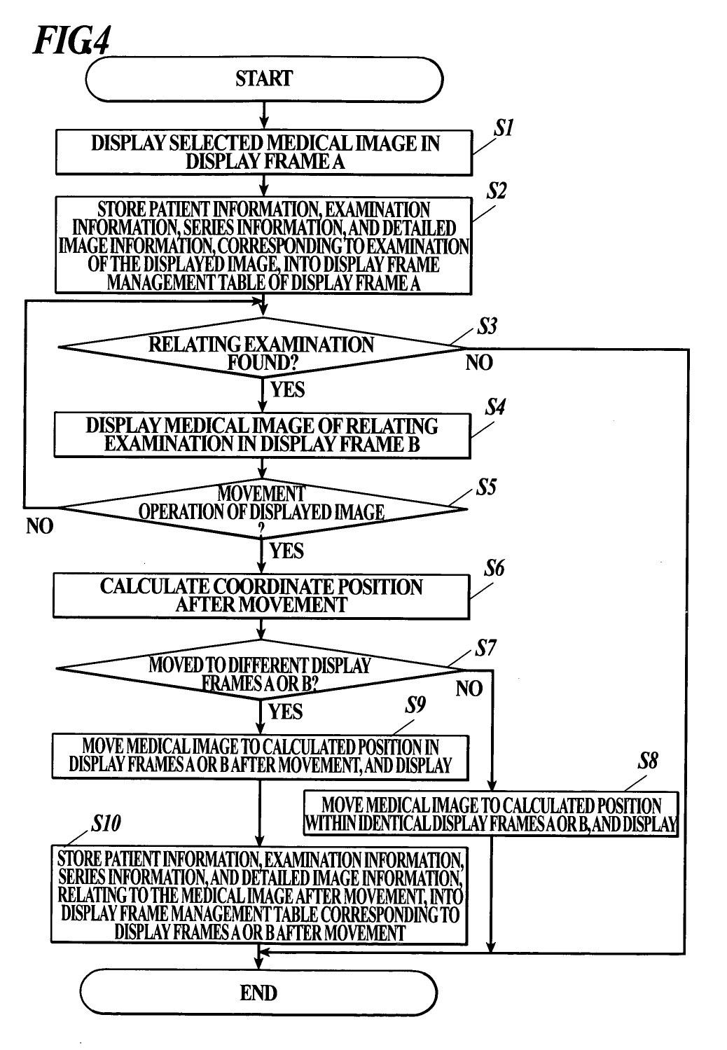

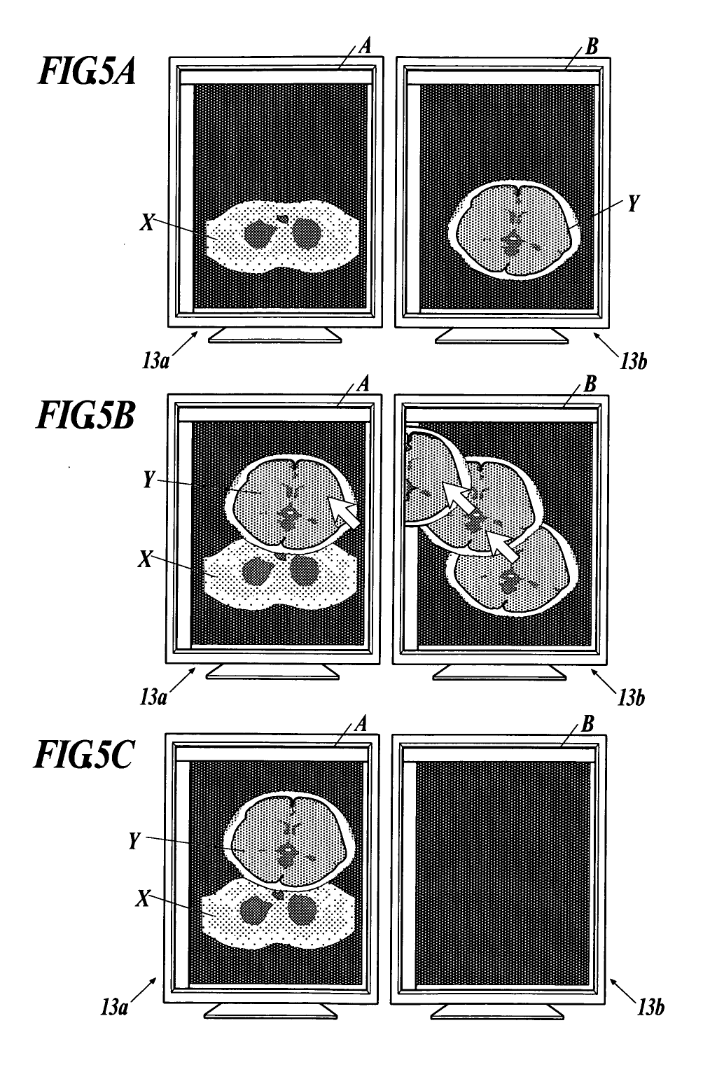

In the image editing processing shown in FIG. 7, the processing first determines whether a synchronous button is depressed by a doctor through the operation unit 12 (step T1). The synchronous button is an operation button to synchronize the contents and operation of processing for the plurality of medical images displayed in the identical display frame with elapse of time. In case the synchronous button is depressed (step T1; Y), all of the displayed images X and Y that are displayed in the identical display frame are selected as shown in FIG. 8A (step T2). Here, a frame described by a solid line in the drawing indicates that the images enclosed within the frame are in a selected state.

On the other hand, in case the synchronous button is not depressed (step T1; N), the doctor can select a displayed image individually, and only the image Y selected by the doctor through the operation unit 12 is in a selected state as shown in FIG. 8B (step T3). Here, even in case of individual selection, a plurality of displayed images can be selected. In this case, selection of all displayed images achieves the identical effect as the case of depressing the synchronous button.

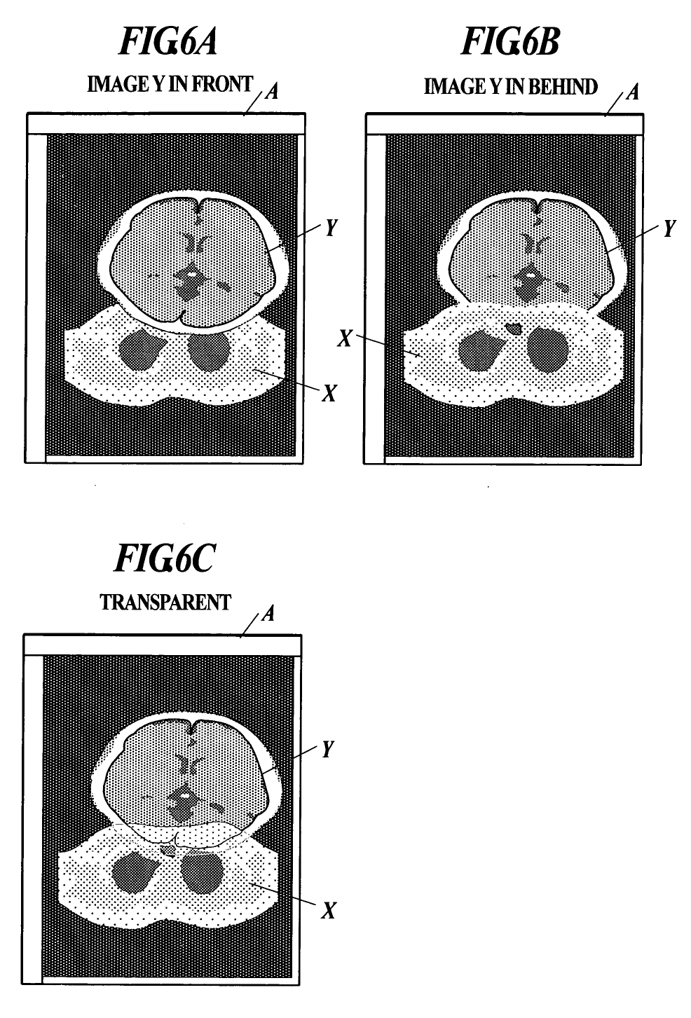

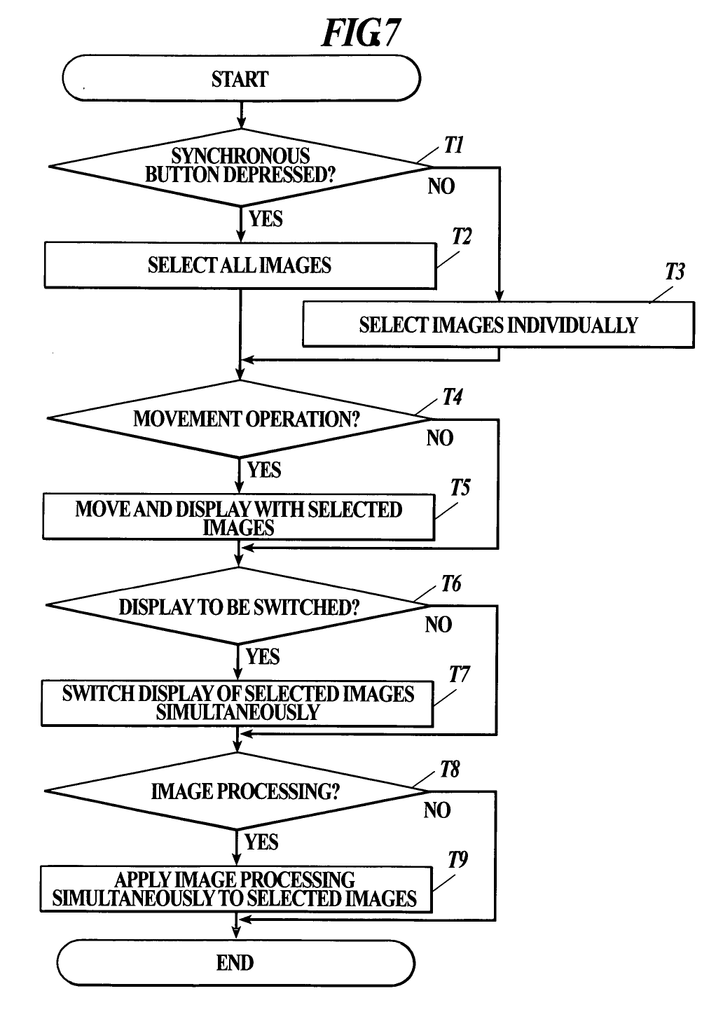

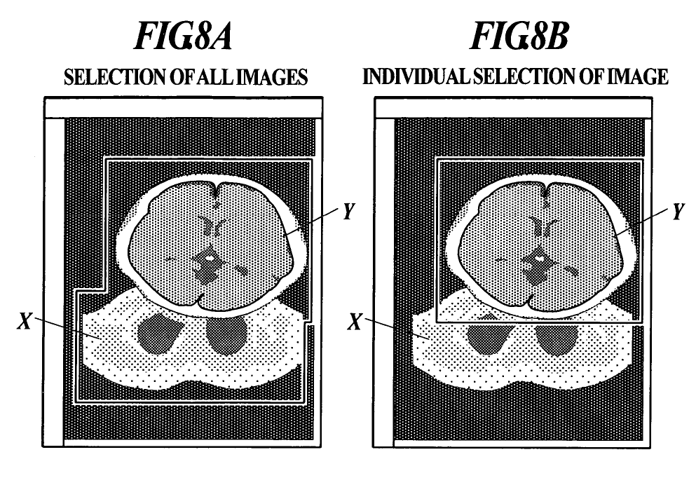

Subsequently, in case a movement operation is applied to the images under the selected state (step T4; Y), both of the displayed images X and Y that are presently selected, as shown in FIG. 9A, are moved by the identical amount of movement in a identical movement direction, and are displayed (step T5). When only one image is selected, only the one image selected is moved and displayed.

Meantime, in case display switching for image is instructed and operated (step T6; Y) other than the movement operation of the images, the displayed images X and Y that are presently selected, as shown in FIG. 9B, are sequentially switched to series of images x1 and x2, and y1 and y2, respectively, and are displayed (step T7). Here, the series of images is a series of images including a plurality of images taken at one time of imaging. In CT and MRI, since a number of tomograms are produced from plural positions at one time of imaging, interpretation of images is often performed sequentially with switching of the display. Concerning the series of images, the series information Z3 of the displayed images X and Y are referred to by the control unit 11, and medical images matching the series number, examination region, and the like are retrieved from the image memory 18, and displayed by switching sequentially.

When only one image is in selected state, the display switching is performed only for the single selected image.

Further, in case the image processing is instructed and operated (step T8; Y), other than the display switching for images, the identical image processing is simultaneously applied to the displayed images that are presently selected (step T9). In case that tone-change processing is instructed, for example, when all of the images X and Y within one display frame are selected, as shown in FIG. 9C, the tone-change processing is simultaneously applied to all of the selected images X and Y with the identical tone-condition. In case only one image is in selected state, the designated image processing is applied only to the single selected image.

As described above, according to the embodiment, even when one medical image is displayed in one display frame, the one medical image can be moved into the other display frame. Therefore, a plurality of medical images subject to comparison for interpretation can be disposed together within one display frame, which allows a doctor to reduce the amount of view-direction movement.

In addition, when displaying a plurality of medical images in the identical display frame, each medical image can be displayed in a superposed state, so that the amount of view-direction movement of the doctor can be reduced to a minimum. Further, in case of superposing medical images, order of arrangement of the images can be switched so that each of the images is disposed in front or in behind. Therefore the display state for easier interpretation can be selected. Further, the overlapping portion can be displayed in a transparent state, which allows image interpretation in a similar observation way as in the image interpretation with films superposed.

Furthermore, movement of the display position and switching to series images can be applied to the plurality of medical images within the identical display frame. Therefore, one operation permits collective display operation for the plurality of medical images, so that working efficiency of the doctor can be improved. Additionally, since image processing can be applied similarly to the medical images within the identical display frame, it is not necessary to set the contents of image processing and image processing conditions to each image one by one. This allows reducing the burden of the doctor concerning image-interpreting work.

In the embodiment described above, a description has been given for the case that one monitor displays one display frame thereon, but in case that one monitor has a plurality of display frames displayed thereon, the aforementioned processing among the display frames is similarly applicable.

The entire disclosure of Japanese Patent Application No. 2005-81725 which was filed on Mar. 22, 2005 is incorporated into the present invention in its entirety.

What is claimed is:

1. A medical image displaying apparatus comprising:
a display unit to display a medical image in a display frame;
an operation unit to instruct movement operation to move the medical image displayed in the display frame into another display frame; and
a display control unit to move the medical image displayed in the display frame into the another display frame and to display according to the movement operation instructed by the operation unit.

2. The medical image displaying apparatus of claim 1, wherein the display control unit displays the medical image and the another medical image in a state of being superposed on each other, in case the medical image is moved to a position where the medical image is superposed on the another medical image by the movement operation.

3. The medical image displaying apparatus of claim 2, wherein the display control unit switches display order for each of the medical image and the another medical image that are displayed in a state of superposition.

4. The medical image displaying apparatus of claim 2, wherein the display control unit displays the medical image and the another medical image, at an overlapped portion, so that a medical image disposed in behind can be observed through a transparent medical image disposed in front.

5. The medical image displaying apparatus of claim 1, wherein the display control unit applies display control to a plurality of medical images displayed in identical display frame.

6. The medical image displaying apparatus of claim 1, further comprising:
an image processing unit to perform image processing to the medical image; and
a processing control unit to apply the image processing to a plurality of medical images displayed in identical display frame.
